(19) United States
(12) Patent Application Publication
(10) Pub. No.: US 2014/0133305 A1
(43) Pub. Date: May 15, 2014

(54) Test Packet Injection System

(71) Applicant: FUJITSU NETWORK COMMUNICATIONS, INC., Richardson, TX (US)

(72) Inventors: Stephen J. Brolin, Livingston, NJ (US); Debbie C. Lun, Old Tappan, NJ (US); Ali Zaringhalam, North Caldwell, NJ (US)

(73) Assignee: Fujitsu Network Communications, Inc., Richardson, TX (US)

(21) Appl. No.: 13/678,312

(22) Filed: Nov. 15, 2012

(51) Int. Cl. H04L 12/26

(52) U.S. Cl. CPC H04L 43/50; H04L 43/026; H04L 47/31
USPC 370/235; 370/250; 370/249

(57) ABSTRACT

A networking device of one embodiment includes a processor, a memory, a networking module, and a traffic manager module. The networking module is configured to receive a packet comprising a first header (the first header comprising information identifying a flow), add a second header to the packet (the second header identifying the packet as a test packet), and assign processing rules to the packet based at least on the information identifying the flow. The traffic manager module is configured to remove one of the first header and the second header from the packet and process the packet in accordance with the processing rules.

### TECHNICAL FIELD

The present invention relates generally to the field of computer networking and more particularly to a test packet injection system.

### BACKGROUND

Conventional IT systems utilize operations, administration, and management (“OAM”) to manage, perform diagnostics, and otherwise administer computer networks. One example of OAM services involves the use of test packets, such as those associated with maintenance entity groups (“MEGs”), and more particularly with MEG end points (“MEPs”). For example, some OAM services utilize Up MEPs, which involve injecting test packets near the ingress point of a MEP. Injecting the packets near the ingress point of the system facilitates the testing of how certain flows are being processed within the system.

### SUMMARY

According to the present invention, certain disadvantages and problems associated with previous systems techniques for injecting test packets may be reduced or eliminated.

According to one embodiment, a networking device includes a processor, a memory, a plurality of network interfaces, a networking module, and a traffic manager module. The networking module is configured to receive a packet comprising a first header (the first header comprising information identifying a flow), add a second header to the packet (the second header identifying the packet as a test packet), and assign processing rules to the packet based at least on the information identifying the flow. The traffic manager module is configured to remove one of the first header and the second header from the packet and process the packet in accordance with the processing rules.

According to another embodiment, a method for identifying and processing a test packet by a network device includes receiving a packet that includes a first header, the first header including information identifying a flow. A second header is added to the packet, the second header identifying the packet as a test packet. Processing rules are assigned to the packet based at least on the information identifying the flow. One of the first header and the second header are removed from the packet, and the packet is processed in accordance with the processing rules.

Particular embodiments of the present invention may provide one or more technical advantages. These systems and methods may facilitate injection of test packets close to the ingress point of the networking device, which may allow the test packet to provide more accurate information about the networking device and its traffic flows. Identifying and processing test packets as described above may also allow for traffic diagnostics to be performed with existing off-the-shelf networking devices, reducing the need for designing, building, and/or purchasing additional hardware. For example, in some embodiments, the test packets may be generated by existing hardware components of the networking device, reducing the need for designing, building, and/or purchasing additional hardware.

Certain embodiments of the present invention may provide some, all, or none of the above advantages. Certain embodiments may provide one or more other technical advantages, one or more of which may be readily apparent to those skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1 illustrates an example network environment.

FIG. 2 illustrates an example networking device.

FIG. 3 illustrates an example networking module.

FIG. 4 illustrates an example traffic manger module.

FIG. 5 is a diagram that illustrates a test packet processing sequence by an example networking device.

### DESCRIPTION OF EXAMPLE EMBODIMENTS

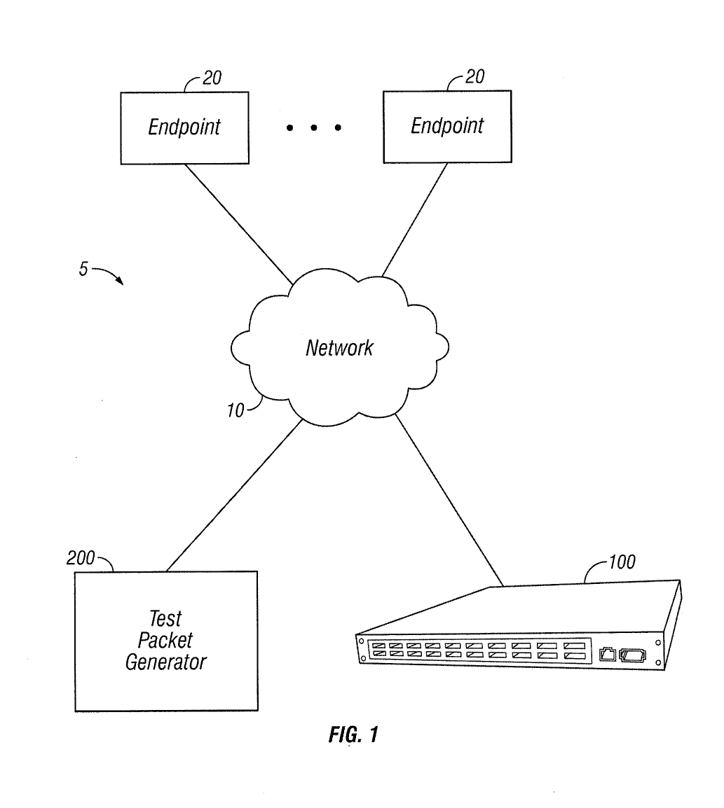

FIG. 1 illustrates an example network environment 5 in which test packets may be generated and sent through a portion of network environment 5. Network environment 5 includes endpoints 20, network 10, test packet generator 200, and networking device 100.

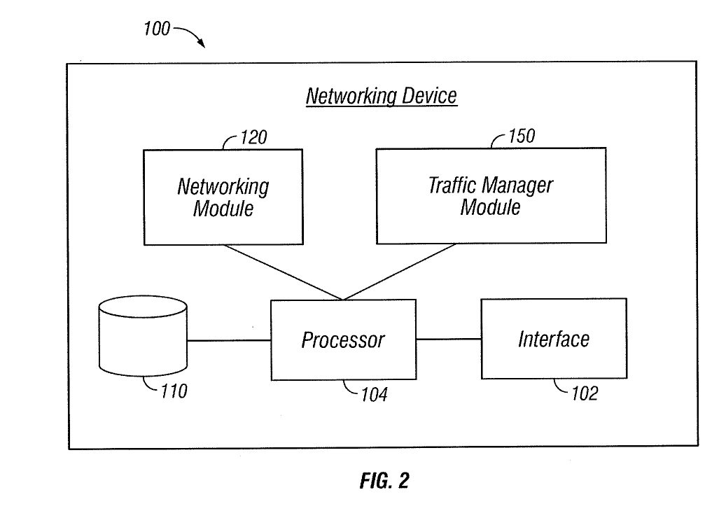

Data packets, or data flows, may be sent through network 10 from one endpoint 20, or a network node of network 10, to another endpoint 20, or another network node of network 10, and these packets may pass through networking device 100. In order to run diagnostics or obtain information about various data flows within networking device 100, test packets may be generated by test packet generator 200 and sent through networking device 100. For example, test packet generator may send test packets through networking device 100 to provide diagnostic, management, or other types of information about networking device 100, or other downstream components of network environment 5, and about various types of traffic moving through them. Such information may include delay, delay variation, packet loss, and other packet or flow information. A second header is added to the test packet, allowing networking device 100 to identify the packet as a test packet and process it accordingly. As part of that processing, the test packets may be given header information that matches at least a portion of the header information of packets in a particular data flow so that traffic manager module 150 (illustrated in FIG. 2) can apply the same processing rules to the test packet that it applies to the data flow. Generating test packets in this manner allows for the injection of test packets close to the ingress point of networking device 100, which may provide more accurate information about networking device 100 and its traffic flows. Identifying and processing test packets in this manner may also allow for traffic diagnostics to be performed with existing off-the-shelf networking devices, reducing the need for designing, building, and/or purchasing additional hardware. For example, in some embodiments, the test packets may be generated by existing hardware components of networking device 100, reducing the need for designing, building, and/or purchasing additional hardware.

As used herein, the terms “flows,” “data flows,” and “test flows” each refer to a sequence of packets communicated from a sending device or sending application to a receiving device or receiving application. These terms may be used to refer to the sequence collectively or to one or more individual packets within the sequence.

According to the illustrated embodiment, network environment 5 includes endpoints 20 that communicate with other endpoints 20 through network 10 and networking device 100. Endpoints 20 may be laptops, personal computers, handheld devices, smartphones, servers, or other suitable components for sending and/or receiving data packets. Endpoints 20 send data packets, or flows, through network 10 and networking device 100. These flows may have headers or other associated information indicating how the data traffic should be handled by network device 100 and/or other portions of network 10. In order to evaluate how these flows are being processed by networking device 100, test packets generated by test packet generator 200 can merge with these data flows and experience the same or similar processing by networking device 100.

Network 10 represents any suitable network operable to facilitate communication between the components of network environment 5. Network 10 may include any interconnecting system capable of transmitting audio, video, signals, data, messages, or any combination of the preceding. Network 10 may include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof operable to facilitate communication between the components. As used herein, network 10 may refer to all or portions of network environment 5. For example, network 10 may be referred to as separate from networking device 100 when describing communication of packets between endpoints 20 and networking device 100, or network 10 may be described as including networking device 100 when discussing communication of data packets between endpoints 20.

Test packet generator 200 represents any suitable components that generate test packets for processing by networking device 100. Test packet generator 200 may be a field-programmable gate array (“FPGA”), computer chip, server, workstation, virtual machine, software, or any other suitable device for generating test packets. Test packet generator 200 may be a separate device communicatively connected to networking device 100 via network 10, a separate device directly connected to networking device 100, or an integral component of networking device 100. In some embodiments, test packet generator 200 is implemented with existing components of networking device 100. For example, as discussed in more detail below in reference to the example embodiment of FIG. 4, test packet generator 200 may be a component of traffic manager module 150. In such embodiments, utilizing existing hardware components of networking device 100 to generate test packets reduces the need to design, build, or purchase additional hardware components to implement network diagnostics and management. Test packet generator 200 may generate different types of test packets, and these packets may be inserted for Up MEP application, Down MEP application, or other applications.

Networking device 100 represents any suitable components that receive packets from one or more components of network 10 and apply one or more processing rules. Networking device 100 may include a switch, router, network server, remote server, workstation, web server, virtual machine, virtual switch, virtual router, or any other suitable networking device operable to communicate with one or more devices over network 10 and process packets. As illustrated in FIG. 1, networking device 100 may include multiple physical ports capable of connecting networking device 100 to network 10, though other embodiments may have a single physical port. The functions of networking device 100 may be performed by any suitable combination of one or more switches or other components at one or more locations, and networking device 100 may include any suitable component that performs networking functions, such as switching or routing.

Networking device 100 is operative to process data packets received from endpoints 20 through network 10 as well as test packets generated by test packet generator 200. These test packets are identified as test packets by networking device 100 and processed such that they undergo the same traffic policing, shaping, and other traffic management procedures within traffic manager module 150 (illustrated in FIG. 2) as corresponding data packets of the related flow. Injecting test packets near the ingress point of networking device 100 and processing the test packets in this manner provides a mechanism for determining how different types of data traffic are being managed by networking device 100 or another component of network environment 5. This mechanism can be utilized to provide diagnostic, management, or other types of information about networking device 100, or other components of network environment 5, and about various types of traffic moving through those components. Such information may include delay, delay variation, packet loss, and other packet or flow information.

FIG. 2 illustrates an example networking device 100, which includes network interface 102, processor 104, memory 110, networking module 120, and traffic manager module 150.

Network interface 102 represents any suitable device or component operable to receive information from network 10, transmit information through network 10, perform suitable processing of the information, communicate to other devices, or any combination thereof. For example, network interface 102 may be any port or connection, real or virtual, including any suitable hardware and/or software, including protocol conversion and data processing capabilities, to communicate through a LAN, WAN, or other communication system that allows networking device 100 to exchange information with network 10, endpoints 20, other networking devices 100, or other components of network environment 5. Network interface 102 is operable to receive data packets from endpoints 20, process the packets according to processing rules, and communicate the packets to endpoint 20 or another component of network environment 5. Network interface 102 may also be utilized to receive test packets. In such cases, network interface 102 is operative to receive test packets from test packet generator 200. Network interface 102 may be a loopback interface of networking device 100. Using a loopback interface may provide an efficient means of injecting test packets near the ingress point of networking device 100 in embodiments where test packet generator 200 is an internal component of networking device 100. Furthermore, the use of an existing loopback interface may facilitate the injection of test packets into existing off-the-shelf devices without requiring additional and potentially expensive hardware or requiring the development of expensive, specialized networking devices. In some embodiments, network interface 102 is a dedicated network interface for test packets. Utilizing a dedicated network interface for test packets may provide an efficient means of identifying and labeling test packets without requiring packet inspection or additional analysis. In some embodiments, network interface 102 is a dedicated loopback interface. In some embodiments, one or more interfaces of network device 100 may be dedicated to loopback of test packets, while the remaining interfaces carry customer packets.

Processor 104 communicatively couples to network interface 102 and memory 110 and controls the operation and administration of networking module 120 and traffic manager module 150 by processing information received from network interface 102 and memory 110. Processor 104 includes any hardware and/or software that operates to control and process information. Processor 104 may be a programmable logic device, a microcontroller, a microprocessor, FPGA, any suitable processing device, or any suitable combination of the preceding.

Memory 110 stores, either permanently or temporarily, data, operational software, or other information for processor 104, other components of networking device 100, or other components of network environment 5. Memory 110 includes any one or a combination of volatile or nonvolatile local or remote devices suitable for storing information. For example, memory 110 may include random access memory (RAM), read only memory (ROM), flash memory, magnetic storage devices, optical storage devices, network storage devices, cloud storage devices, or any other suitable information storage device or a combination of these devices. Memory 110 may include any suitable information for use in the operation of networking device 100. For example, memory 110 may include logic or processing rules that are operative to control the processing of packets by networking device 100. Memory 110 may be separate from other components of networking device 100, or it may be integrated with one or more components of networking device 100. As an example, in some embodiments, memory 110, or a portion of memory 110, may be integrated with an FPGA implementing traffic manager module 150.

Networking module 120 represents any suitable hardware; any suitable set of instructions, logic, or code embodied in a computer-readable storage medium; or any combination thereof that is operable to control the processing of packets by networking device 100. Networking module 120 is operative to process packets received by network interface 102 and modify, classify, or otherwise process the packets before or after the packets are processed by traffic manager module 150. Such processing may include adding or removing headers, translating, copying header information, assigning packet priority information, assigning an ingress or egress profile that defines how the packet is to be processed, assigning a destination interface indicating the interface to which the packet is to be sent after processing. The operation of networking module 120 may be determined by local or remote hardware configuration, local or remote software configuration, or any combination thereof.

In some embodiments, networking module 120 processes a test packet received by network interface 102, which may be a loopback interface. The test packet includes a first header, such as a VLAN header, that identifies a flow. This header may be the same as a header of other data packets whose processing the test packet is intended to mirror. For example, the test packet may contain internal ingress VLAN information matching the internal ingress VLAN information for the data flow the test packet is intended to analyze. Network interface 102 or networking module 120 may add a second header to the test packet that identifies the packet as a test packet. The addition of the second header may allow test packets with VLAN information matching existing data flows from colliding with the corresponding data packets, or creating other processing errors, within network module 120. The addition of the second header may also facilitate efficient identification and processing of the test packets by subsequent components of networking device 100.

Networking module 120 then assigns processing rules to the packet based on information contained in the first header, the second header, or both, so that the same processing rules will be applied to the test flow and its corresponding data flow by traffic manager module 150. These processing rules include packet priority information, an ingress profile, an egress profile, a destination interface, and/or other rules indicating how the packet is to be processed. Networking module 120 may also assign information indicating a class of service (“CoS”), such as, for example, the CoS field described in Institute of Electrical and Electronics Engineers (“IEEE”) standard 802.1 Q. Networking module 100 also assigns to the test packet a class tag that allows traffic manager module 150 to identify the packet as a test packet. Networking module 100 may then write or copy the information in the first header into the second header, so that the first and second headers include the same information. This copying may including writing the entire contents or a substantial portion of the contents of the first header into the second header. At any suitable point in the flow, either the first or second header can then be removed (since they now contain the same information), at which point the test packet more closely resembles a data packet in the corresponding flow. The test packet is then passed to traffic manager module 150. After processing by traffic manager module 150, the packet may be returned to networking module 120, or another module, for egress processing. Such egress processing may include assigning egress packet priority, such as Ethernet “p” bits, based on the packet's CoS and/or egress profile and sending the packet to the indicated destination interface. The operation of networking module 120 allows networking device 100 to efficiently identify test packets and prepare them for processing by traffic manager module 150. Furthermore, networking modules 120, in conjunction with the use of a network interface 102 dedicated to the injection of test packets, may reduce the need for additional or specialized hardware, providing a simplified and cost-effective means of performing traffic diagnostics and/or management. Traffic manager module 150 represents any suitable hardware; any suitable set of instructions, logic, or code embodied in a computer-readable storage medium; or any combination thereof that is operable to perform traffic policing, traffic shaping, and/or other traffic processing. For example, in some embodiments, traffic manager module 150 is an FPGA or other hardware component configured to enforce processing rules when processing packets.

In operation, traffic manager module 150 receives packets—which may be data packets, test packets, or other types of packets—that have been processed by networking module 120. Traffic manager module 150 examines a class tag of the packet to identify the packet's type. If traffic manager module 150 identifies a class tag identifying the packet as a test packet, it removes either the first or second header, which now contain duplicate information, as described above. In other embodiments, networking module 120 may remove the first or second header before passing the packet to traffic manager module 150. Upon the removal of the duplicate header, the test packet appears to be part of the same data flow as data packets having the same or similar header information. Based on processing rules and/or other information associated with the test packet, traffic manager module 150 performs traffic policing, shaping, and or other processing on the test packet. Traffic manager module 150 may also perform header translation, such as translating VLAN information in the first header to egress VLAN information, and assign an egress profile in order to facilitate egress processing by networking module 120. Upon performing the traffic policing, shaping, and other processing indicated by the processing rules and other information associated with the packet, traffic manager module 150 passes the packet to networking module 120, or another module, for egress processing.

Processing of the test packet by traffic manager module 150, and subsequent egress processing, may occur similarly or identically to the processing of data packets having the same or similar header information. This allows the test packets to experience the same packet processing within networking device 100, or other downstream components of network environment 5, as the associated data packets, facilitating traffic diagnostics and management, such as OAM operations. Furthermore, in some embodiments, traffic manager module 150 may be configured to operate as test packet generator 200 as well, generating the test packets and sending them to a dedicated loopback port of networking device 100. This may provide a simplified mechanism for performing traffic diagnostics and management without requiring additional hardware or the development of expensive, specialized networking devices 100 or components thereof.

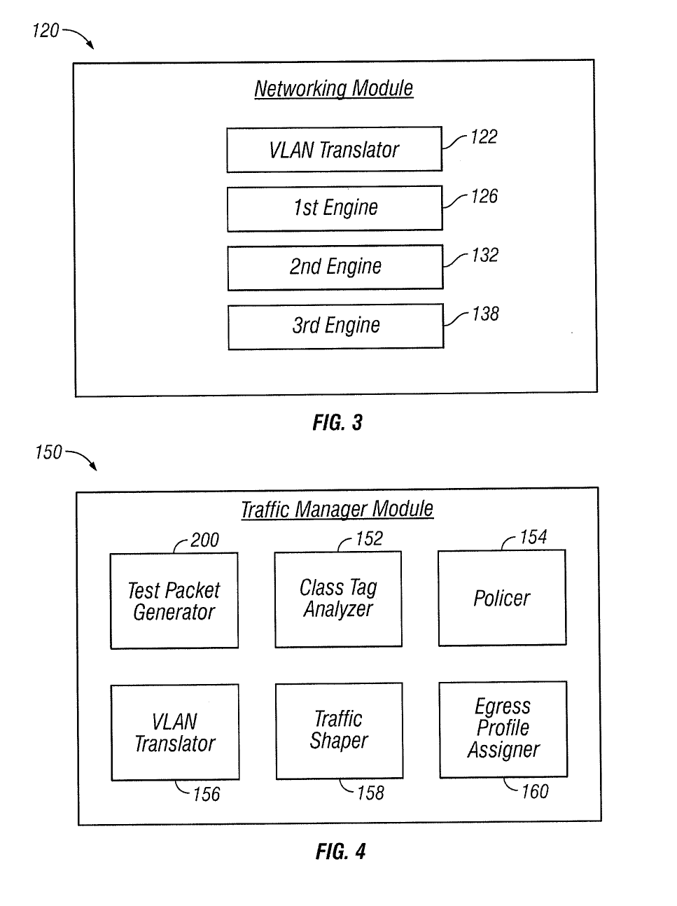

FIG. 3 illustrates an example networking module 120, which includes VLAN translator 122, first engine 126, second engine 132, and third engine 138. Networking module 120 is operative to process packets received by network interface 102 and modify, classify, or otherwise process the packets before or after the packets are processed by traffic manager module 150. For example, networking module 120, or one or more of its components, may be operative to process ingressing packets before they are processed by traffic manager module 150, egressing packets after they are processed by traffic manager module 150, or both ingressing and egressing packets. Such processing includes adding, removing, and/or translating headers, copying header information, assigning packet priority information, assigning an ingress or egress profile that defines how the packet is to be processed, assigning a destination interface indicating the interface to which the packet is to be sent after processing. The operation of networking module 120 may be determined by local or remote hardware configuration, local or remote software configuration, or any combination thereof. In the illustrated embodiment, various functions of networking module 120 are implemented by VLAN translator 122, first engine 126, second engine 132, and third engine 138. In some embodiments, one or more of these components may be implemented by configuring existing software and/or hardware components of an off the shelf networking device, which may provide a cost-effective mechanism for network management and diagnostics.

VLAN translator 122 represents any suitable hardware; any suitable set of instructions, logic, or code embodied in a computer-readable storage medium; or any combination thereof that is operable to translate VLAN header information included in a packet. These packets may be data packets, test packets, or any other type of packet. VLAN translator 122 may be operative to process ingressing packets before they are processed by traffic manager module 150, egressing packets after they are processed by traffic manager module 150, or both ingressing and egressing packets. The translation of external VLANs to internal VLANs, and vice versa, facilitates particularized processing of various flows within networking device 100 without interfering with the downstream processing of the packets once they have exited networking device 100.

When processing ingressing packets, VLAN translator 122 translates an external VLAN header into an internal VLAN header, which may be unique. Alternatively, internal VLAN information may be stacked over the external VLAN information in the ingressing packets. The packets that make up an ingress flow include header information, such as VLAN header information. This VLAN header information may be associated with internal VLAN information, such as an internal ingress VLAN, that is used to determine processing in one or more components of networking module 120 or traffic manager module 150. VLAN translator 122 identifies external VLAN information in the header and translates this into internal VLAN information. For example, VLAN translator 122 may perform an internal ingress VLAN look up in a database in memory 110 to find an internal ingress VLAN associated with the external VLAN information. After VLAN translation, the ingressing flow processed by first engine 126. The internal VLAN may be unique within system 5 (or within components of system 5). Unique internal VLAN information may enable the look-up of flow information using only the internal VLAN, without requiring additional information such as the corresponding ingress port. In certain embodiments, a unique internal VLAN may be necessary to operate with one or more vendor devices used in system 5.

When processing egressing packets, VLAN translator 122 translates an internal VLAN header into an external VLAN header to prepare the packets for exiting networking device 100. While in some embodiments, VLAN translator 122 operates as part of traffic manger module 150, in other embodiments, VLAN translator 122 may operate as part of another component and may be situated just prior to egress. Traffic manager 150 may translate internal ingress VLAN information into internal egress VLAN information. In such cases, VLAN translator 122 is operative to translate the internal egress VLAN information into external VLAN information. For example, VLAN translator 122 may replace or overwrite the internal egress VLAN information contained in a VLAN header of an egressing packet with external VLAN information. Updating the packets with external VLAN information prepares them for exiting networking device 100. In certain embodiments, VLAN translator 122 removes one or more headers or tags that were previously added to the packets.

First engine 126 represents any suitable hardware; any suitable set of instructions, logic, or code embodied in a computer-readable storage medium; or any combination thereof that is operable to inspect packet headers of ingressing packets and process the packets. These packets may be data packets, test packets, or any other type of packet. When processing ingressing packets, first engine 126 is operative to assign processing rules to the packets based on the internal ingress VLAN information and/or other header information. The processing rules may include a destination interface of networking device 100 and an ingress profile. These assignments may entail adding header information to the packet, replacing header information or portions of header information, storing information in networking device 100, other suitable methods, or any combination thereof The destination interface indicates the port or other interface of networking device 100 to which the packet is to be directed as it exits networking device 100. The ingress profile includes information that determines how the packet is to be processed by networking device 100.

First engine 126 is also operable to process test packets. When first engine 126 processes a test packet, which has a first VLAN header containing the same VLAN information as a particular data flow with which it is associated and a second VLAN header identifying the packet as a test packet, first engine 126 assigns the destination interface and ingress profile associated with the first VLAN header. In other words, first engine 126 assigns to the test packet the same destination interface and ingress profile that it would assign to the data flow with which the test packet is associated. This allows the test packet to receive the same processing as the data flow by traffic manager module 150.

Second engine 132 represents any suitable hardware; any suitable set of instructions, logic, or code embodied in a computer-readable storage medium; or any combination thereof that is operable to assign processing rules to packets. These packets may be data packets, test packets, or any other type of packet. Second engine 132 may be operative to process ingressing packets before they are processed by traffic manager module 150, egressing packets after they are processed by traffic manager module 150, or both ingressing and egressing packets. When processing ingressing packets, second engine 132 is operative to assign processing rules, such as internal packet priority, CoS, and a class tag. This processing may entail adding header information to the packet, replacing header information or portions of header information, storing information in networking device 100, other suitable methods, or any combination thereof. Internal packet priority indicates how the packet should be treated by networking device 100. For example, packet priority information may be one of four priority indicators (such as A, B, C, or D) that may influence scheduling or processing of the packet. CoS indicates a class of service, such as, for example, the CoS field described in IEEE standard 802.1Q. The class tag indicates a flow type and can be used by traffic manager module 150 to determine how the packet is to be processed. For example, the class tag may indicate that the packet is a test packet, a certain type of test packet, a data packet, a certain type of data packet, or another type of packet altogether.

Second engine 132 is also operable to process test packets. When second engine 132 processes a test packet, which has a first VLAN header containing the same VLAN information as a particular data flow with which it is associated and a second VLAN header identifying the packet as a test packet, as described above, second engine 132 assigns the CoS and/or internal packet priority based on the ingress profile and, optionally, external packet priority associated with the packet. In other words, first engine 126 assigns to the test packet the same processing rules that it would assign to the data flow with which the test packet is associated. This allows the test packet to undergo the same traffic policing, shaping, and other traffic management procedures within traffic manager module 150 as the data flow (or other type of flow) with which the test packet is associated while also providing an efficient mechanism for traffic manager module 150 to identify test packets and execute additional processing steps as needed.

Third engine 138 represents any suitable hardware; any suitable set of instructions, logic, or code embodied in a computer-readable storage medium; or any combination thereof that is operable to modify packet header information. Third engine 138 is operative to process ingressing test packets before they are processed by traffic manager module 150. This processing includes copying the VLAN information in the test packet's first VLAN header (which includes internal ingress VLAN information, as described above) into the test packet's second VLAN header, resulting in two headers containing the same VLAN information. Copying the internal ingress VLAN information into the second VLAN header may simplify the processing required of traffic manager module 150, which can drop either the first or second VLAN header once it identifies the packet as a test packet since both headers contain the same information at this point.

FIG. 4 illustrates an example traffic manger module 150, which includes test packet generator 200, class tag analyzer 152, policer 154, VLAN translator 156, traffic shaper 158, and egress profile assignor 160.

Traffic manager module 150 represents any suitable hardware; any suitable set of instructions, logic, or code embodied in a computer-readable storage medium; or any combination thereof that is operable to perform traffic policing, traffic shaping, and/or other traffic processing. For example, in some embodiments, traffic manager module 150 is an FPGA or other hardware component configured to enforce processing rules when processing packets. Traffic manager module 150 receives packets—which may be data packets, test packets, or other types of packets—that have been processed by networking module 120 and applies policing, shaping, and other processing rules.

Test packet generator 200 represents any suitable components that generate test packets for processing by networking device 100. Test packet generator 200 may be implemented as part of an FPGA, a computer chip, a virtual machine, software, or any other suitable device or component for generating test packets. In the illustrated embodiment, test packet generator 200 is implemented as part of traffic manager module 150, though in other embodiments test packet generator 200 may be a separate component of networking device 100, or it may be an entirely separate device that communicates test packets to networking device 100 through network 10. Utilizing existing hardware components of networking device 100 to generate test packets reduces the need to design, build, or purchase additional hardware components to implement network diagnostics and management.

Class tag analyzer 152 represents any suitable hardware; any suitable set of instructions, logic, or code embodied in a computer-readable storage medium; or any combination thereof that is operable to identify a class tag associated with a packet and process the packet based on that class tag. When traffic manager module 150 receives a packet after it has been processed by networking module 120, class tag analyzer 152 determines a class tag associated with the packet. The class tag may be included as part of the packet's header or associated with the packet by other means. For example, in some embodiments, the class tag may be associated with the packet's VLAN information in a database. Once class tag analyzer 152 determines the class tag, the packet is processed accordingly. For example, when class tag analyzer 152 identifies a class tag indicating that the packet is a test packet, class tag analyzer 152, or another component of traffic manager module 150, removes either the first VLAN header or the second VLAN header (both of which contain the same VLAN information, as described above). Processing packets in this manner allows the test packets to now appear as if they are part of the same flow as the corresponding data packets. The test packet thus effectively merges with the data flow as it undergoes subsequent processing in policer 154, VLAN translator 156, traffic shaper 158, and egress profile assignor 160.

Policer 154 represents any suitable hardware; any suitable set of instructions, logic, or code embodied in a computer-readable storage medium; or any combination thereof that is operable to enforce an ingress traffic contract. Certain traffic flows may have processing rules assigned to them that indicate that certain packet priority, CoS, or other policing rules apply. Policer 154 applies these rules based at least partially on the internal ingress VLAN associated with the packet, the internal packet priority assigned to the packet, and/or the CoS associated with the packet. Since the test packets have effectively merged with the corresponding data flow at this point, test packets undergo the same policing by policer 154 as the data flow. This allows subsequent analysis of the test packets to yield information about the processing of that data flow. Following traffic policing, packets are processed by VLAN translator 156.

VLAN translator 156 represents any suitable hardware; any suitable set of instructions, logic, or code embodied in a computer-readable storage medium; or any combination thereof that is operable to translate VLAN header information included in a packet. These packets may be data packets, test packets, or any other type of packet. VLAN translator 156 is operative to translate the internal ingress VLAN information into internal egress VLAN information. VLAN translator 156 identifies internal ingress VLAN information in the VLAN header and translates this into internal egress VLAN information. For example, VLAN translator 156 may perform an internal egress VLAN look up in a database in memory 110, or in another database, to determine an internal egress VLAN associated with the internal ingress VLAN information. The translation of internal ingress VLAN information to internal egress VLAN information facilitates the setting of an egress profile by egress profile assignor 160. Following translation of the VLAN information, the packets are processed by traffic shaper 158.

Traffic shaper 158 represents any suitable hardware; any suitable set of instructions, logic, or code embodied in a computer-readable storage medium; or any combination thereof that is operable to perform traffic shaping on one or more data flows. Traffic shaping may involve smoothing egress traffic of one or more flows and other methods of modifying the flow of packets as they leave networking device 100. Traffic shaper 158 may perform traffic shaping based on information associated with the packet's destination interface, information associated with the particular flow, general rules, and/or other factors. Again, since the test packets have effectively merged with the corresponding data flow at this point, test packets undergo the same shaping by traffic shaper 158 as the data flow. This allows subsequent analysis of the test packets to yield information about the processing of that data flow. Following traffic shaping, packets are processed by egress profile assignor 160.

Egress profile assignor 160 represents any suitable hardware; any suitable set of instructions, logic, or code embodied in a computer-readable storage medium; or any combination thereof that is operable to determine VLAN information associated with a packet and set an egress profile based on that information. These packets may be data packets, test packets, or any other type of packet. As described above, VLAN translator 156 replaces the internal ingress VLAN information with internal egress VLAN information. Egress profile assignor 160 identifies the internal egress VLAN information in the VLAN header and determines an egress profile associated with the information. For example, egress profile assignor 160 may perform an egress profile look up in a database in memory 110, or in another database, to determine the egress profile associated with the VLAN information. Egress profile assignor then sets the egress profile for the packet, which may include adding header information to the packet, replacing header information or portions of header information, storing information in networking device 100, other suitable methods, or any combination thereof. After the assignment of the egress profile, the packet is sent to networking module 120, which includes components capable of performing egress processing, or to another module operative to perform egress processing.

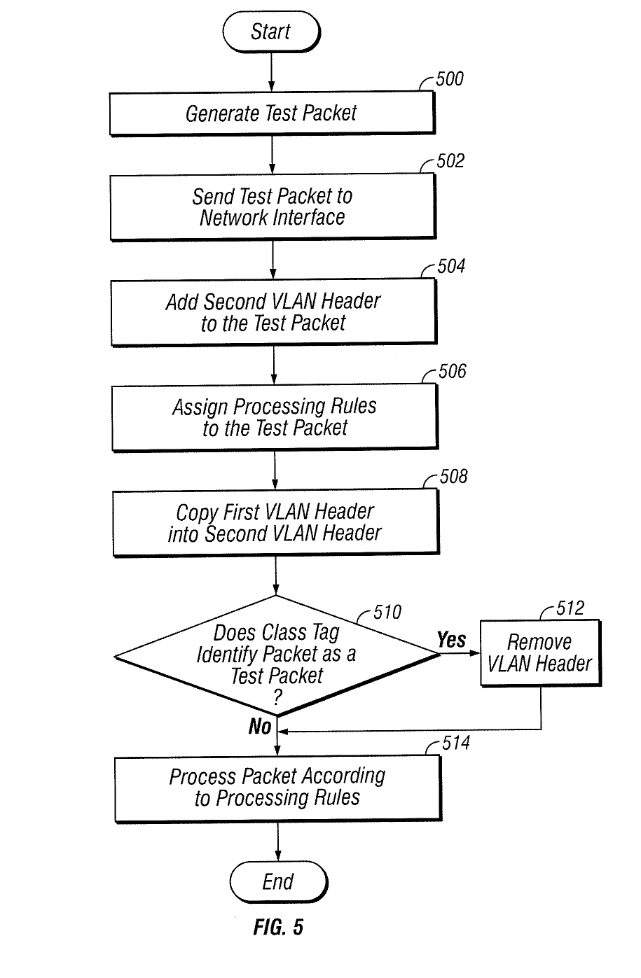

FIG. 5 is a diagram that illustrates a test packet processing sequence by networking device 100.

At step 500, a test packet is generated by test packet generator 200. Test packet generator 200 may be a separate device communicatively connected to networking device 100 via network 10, a separate device directly connected to networking device 100, or an integral component of networking device 100. In some embodiments, test packet generator 200 is implemented with existing components of networking device 100. For example, as discussed above in reference to FIG. 4, test packet generator 200 may be a component of traffic manager module 150. In such embodiments, utilizing existing hardware components of networking device 100 to generate test packets reduces the need to design, build, or purchase additional hardware components to implement network diagnostics and management. The generated test packets may be Up MEPs, other types of test packets, or any combination thereof. The test packet may contain internal ingress VLAN information matching the internal ingress VLAN information for the data flow the test packet is intended to analyze.

At step 502, the test packet is sent to network interface 102 of networking device 100. In embodiments in which test packet generator 200 is an internal component of networking device 100, the network interface 20 receiving the test packet may be a loopback interface. Using a loopback interface may provide an efficient means of injecting test packets near the ingress point of networking device 100 from an internal component of networking device 100, which may allow OAM services to obtain more accurate information about networking device 100 and its traffic flows. Furthermore, the use of an existing loopback interface may facilitate the injection of test packets into existing off-the-shelf devices without requiring additional and potentially expensive hardware or requiring the development of expensive, specialized networking devices. In some embodiments, network interface 20 is a dedicated network interface for test packets. Utilizing a dedicated network interface for test packets may provide an efficient means of identifying and labeling test packets without requiring packet inspection or additional analysis. In some embodiments, network interface 20 is a dedicated loopback interface.

At step 504, a second VLAN header is added to the test packet. The second VLAN header contain information identifying the packets as test packets. The VLAN information contained in the second VLAN header may contain the same priority bits as the VLAN information in the first VLAN header. The addition of the second VLAN header may prevent test packets with VLAN information matching existing data flows from colliding with the corresponding data packets, or creating other processing errors, within network module 120. The addition of the second VLAN header may also facilitate efficient identification and processing of the test packets by subsequent components of networking device 100.

At step 506, the test packet is assigned processing rules. Assigning processing rules may entail adding header information to the packet, replacing header information or portions of header information, storing information in networking device 100, other suitable methods, or any combination thereof. The assignment of processing rules may be based on the internal ingress VLAN information contained in one or more of the test packet's VLAN headers, which facilitates the assignment and application of the same processing rules to the test flow and its corresponding data flow. The processing rules may include packet priority information, an ingress profile, an egress profile, a destination interface, CoS, a class tag, and/or other rules indicating how the packet is to be processed. The destination interface indicates the port or other interface of networking device 100 to which the packet is to be directed as it exits networking device 100. The ingress profile includes information that determines how the packet is to be processed during ingress by networking device 100. The egress profile includes information that determines how the packet is to be processed during egress. In some embodiments, CoS includes the CoS field described in IEEE standard 802.1 Q, while in other embodiments, CoS may include other types of CoS information. The class tag allows traffic manager module 150 to identify the packet as a test packet during subsequent processing.

The assignment of processing rules in step 506 may also be based on previously assigned processing rules. For example, CoS may be assigned to the test packet based on the previously assigned ingress profile and/or packet priority. Furthermore, the assignment of processing rules may occur in any order, and may be performed by different components of networking device 100. For example, networking device 100 may include multiple engines, with one engine assigning an ingress profile and a destination port to the packet based on internal ingress VLAN information associated with the packet, while another engine assigns CoS based on the packet's ingress profile and packet priority and assigns a class tag based at least on VLAN information. In step 506, packets identified as test packets are assigned a class tag identifying them as test packets so that traffic manager module 150 can identify them and process them appropriately, as described below in reference to steps 510 and 512.

At step 508, the information in the test packet's first VLAN header is copied into the second VLAN header, so that the first and second VLAN headers include the same information. Copying the VLAN information in this manner allows either the first VLAN header or the second VLAN header to be dropped by traffic manager module 150. Furthermore, since at this step the packet has been assigned a class tag identifying it as a test packet, the information in the second VLAN header identifying the packet as a test packet may be redundant.

At step 510, traffic manager module 150 determines whether the class tag identifies the packet as a test packet. If not, the sequence proceeds to step 514. If so, traffic manager module 150 removes a VLAN header from the test packet. Since, as described above, the first and second VLAN headers now include the same information, either the first or second VLAN header may be dropped. Dropping the additional VLAN header allows the test packet to now merge with its corresponding data flow for processing by traffic manager module 150 during step 514.

At step 514, traffic manager module 150 processes the packet according to its assigned processing rules. Since the processing rules assigned to the test packet are the same as the processing rules assigned to its corresponding data flow, the test flows undergo substantially similar processing by traffic manager module 150 once the flows have effectively merged. For example, the test flows undergo the same shaping, policing, VLAN translation, and/or egress profile assignment as their associated data flows. After processing by traffic manager module 150, the packet may be returned to networking module 120, or another module, for egress processing. Such egress processing may include assigning egress packet priority, such as Ethernet “p” bits, based on the packet's CoS and/or egress profile and sending the packet to the assigned destination interface. Egress processing may also include translating and/or stripping internal egress VLAN information.

Various embodiments may perform some, all, or none of the steps described above. For example, certain embodiments may omit steps 508, 510, and 512 under certain conditions, or they may omit these steps entirely. Certain embodiments may also perform the above-described steps in different orders. For example, in one embodiment, step 508 may be performed before step 506, and in another embodiment, step 526 may be performed before step 512. Furthermore, certain embodiments may perform one or more additional steps at various points in the sequence. For example, some embodiments may perform egress processing after step 514.

Herein, “or” is inclusive and not exclusive, unless expressly indicated otherwise or indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, “A and B” means “A and B, jointly or severally,” unless expressly indicated otherwise or indicated otherwise by context.

Particular embodiments may be implemented as hardware, software, or a combination of hardware and software. As an example and not by way of limitation, one or more computer systems may execute particular logic or software to perform one or more steps of one or more processes described or illustrated herein. Software implementing particular embodiments may be written in any suitable programming language (which may be procedural or object oriented) or combination of programming languages, where appropriate. In various embodiments, software may be stored in computer-readable storage media. Any suitable type of computer system (such as a single- or multiple-processor computer system) or systems may execute software implementing particular embodiments, where appropriate. A general-purpose computer system may execute software implementing particular embodiments, where appropriate. In certain embodiments, portions of logic may be transmitted and or received by a component during the implementation of one or more functions.

Herein, reference to a computer-readable storage medium encompasses one or more non-transitory, tangible, computer-readable storage medium possessing structures. As an example and not by way of limitation, a computer-readable storage medium may include a semiconductor-based or other integrated circuit (IC) (such as, for example, an FPGA or an application-specific IC (ASIC)), a hard disk, an HDD, a hybrid hard drive (HHD), an optical disc, an optical disc drive (ODD), a magneto-optical disc, a magneto-medium, a solid-state drive (SSD), a RAM-drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 104, one or more portions of memory 110, one or more portions of networking module 120, one or more portions of traffic manager module 150, or a combination of these, where appropriate. In particular embodiments, a computer-readable storage medium implements RAM or ROM. In particular embodiments, a computer-readable storage medium implements volatile or persistent memory.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, various embodiments may perform all, some, or none of the steps described above. Various embodiments may also perform the functions described in various orders.

Various embodiments disclosed herein may be used together in a variety of combinations. In various embodiments, networking device 100 may have different types, numbers, and configurations of interface 102, processor 104, memory 110, networking module 120, and/or traffic manager module 150. For example, networking device may utilize different types of test packet generator 200 concurrently, and any of these test packet generators 200 may be a separate component configured to communicate with networking device 100 or may be incorporated into networking device 100. Furthermore, the functionality of networking device 100 may be implemented using any number and types of hardware and/or software. For example, some embodiments may utilize three engines as described above in reference to FIG. 3, while others may utilize more, fewer, or none at all. Furthermore, any such engines may be implemented with hardware, software, or any combination thereof.

Although the present invention has been described above in connection with several embodiments; changes, substitutions, variations, alterations, transformations, and modifications may be suggested to one skilled in the art, and it is intended that the present invention encompass such changes, substitutions, variations, alterations, transformations, and modifications as fall within the spirit and scope of the appended claims.

What is claimed is:

1. A networking device, comprising:
a processor;
a memory;
a networking module configured to:
receive a packet comprising a first header, the first header comprising information identifying a flow;
add a second header to the packet, the second header identifying the packet as a test packet; and
assign processing rules to the packet based at least on the information identifying the flow; and
a traffic manager module configured to:
remove one of the first header and the second header from the packet; and
process the packet in accordance with the processing rules.

2. The networking device of claim 1, further comprising a loopback interface, wherein:
receiving the packet comprises receiving a packet at the loopback interface; and
adding the second header to the packet occurs in response to receiving the packet at the loopback interface of the networking device.

3. The networking device of claim 1, wherein the processing rules comprise at least one of:
packet priority information;
an ingress profile; and
a destination interface of the networking device.

4. The networking device of claim 1, wherein the packet is an Up MEP packet.

5. The networking device of claim 1, wherein the networking module is further configured to copy the information identifying the flow into the second header such that the first and second headers each comprise the information identifying the flow.

6. The networking device of claim 1, wherein:
the networking module is further configured to assign class of service (CoS) information to the packet, the CoS information indicating a CoS associated with the packet; and
the traffic manager module is further configured to read the CoS information and process the packet in accordance with the CoS information.

7. The networking device of claim 1 wherein:
the networking module is further configured to assign a class header to the packet, the class header comprising information identifying the packet as a test packet;
the traffic manager module is further configured to read the class header; and
the traffic manager module is further configured to remove one of the first header and the second header from the packet in response to reading the class header comprising information identifying the packet as a test packet.

8. The networking device of claim 2, wherein the traffic manager module is further configured to generate the packet and send the packet to the loopback interface.

9. The networking device of claim 1, wherein the traffic manager module comprises a field-programmable gate array.

10. The networking device of claim 1, wherein the packet is generated by a device that is separate from the traffic manager module.

11. A method for identifying and processing a test packet performed by a networking device, the method comprising:
receiving a packet comprising a first header, the first header comprising information identifying a flow;
adding a second header to the packet, the second header identifying the packet as a test packet;
assigning processing rules to the packet based at least on the information identifying the flow;
removing one of the first header and the second header from the packet; and
processing the packet in accordance with the processing rules.

12. The method of claim 11, wherein:
receiving the packet comprises receiving the packet at a loopback interface of the networking device; and
adding the second header to the packet occurs in response to receiving the packet at the loopback interface.

13. The method of claim 11, wherein the processing rules comprise at least one of:
packet priority information;
an ingress profile; and
a destination interface of the networking device.

14. The method of claim 11, wherein the packet is an Up MEP packet.

15. The method of claim 11, further comprising copying the information identifying the flow into the second header such that the first and second headers each comprise the information identifying the flow.

16. The method of claim 11, further comprising:
assigning to the packet class of service (CoS) information indicating a CoS associated with the packet;
reading the CoS information; and
processing the packet in accordance with the CoS information.

17. The method of claim 11, further comprising:
assigning to the packet a class header comprising information identifying the packet as a test packet; and
reading the class header;
wherein removing one of the first header and the second header from the packet occurs in response to reading the class header.

18. The method of claim 12, wherein the packet is generated by the networking device and wherein the networking device sends the packet to the loopback interface.

19. The method of claim 11, wherein:
the networking device comprises a switching device and a field-programmable gate array; and
removing the one of the first header and the second header from the packet and processing the packet in accordance with the processing rules are performed by the field-programmable gate array.

20. The method of claim 11, wherein:
removing one of the first header and the second header from the packet and processing the packet in accordance with the processing rules are performed by a traffic manager module of the networking device; and
the packet is generated by a device that is separate from the traffic manager module.
